(19) United States
(12) Patent Application Publication
(10) Pub. No.: US 2026/0070571 A1
(43) Pub. Date: Mar. 12, 2026

(54) DRIVING CONTROL APPARATUS

(71) Applicant: Honda Motor Co., Ltd., Tokyo (JP)

(72) Inventors: Shinya Sato, Tokyo (JP); Renji Kuriyama, Tokyo (JP); Shuhei Kawamura, Tokyo (JP); Toshiki Miyoshi, Tokyo (JP); Koichiro Ozaki, Tokyo (JP); Masatoshi Saito, Tokyo (JP)

(21) Appl. No.: 19/321,825

(22) Filed: Sep. 8, 2025

(30) Foreign Application Priority Data
Sep. 12, 2024 (JP) 2024-158134

(51) Int. Cl. B60W 50/08; B60W 50/00

(52) U.S. Cl. CPC B60W 50/08; B60W 50/0098

(57) ABSTRACT

The driving control apparatus includes a microprocessor configured to output a first target value for controlling a predetermined operation of a moving object based on a first operation request, output a second target value for controlling the predetermined operation based on a second operation request, and execute the control based on the first and second target values. When the first target value before being limited to a first upper limit value is greater than the second target value and the second target value is greater than the first upper limit value set for the first target value, the microprocessor controls the predetermined operation based on the first target value until a control amount reaches the first upper limit value, and, after the control amount reaches the first upper limit value, controls the predetermined operation based on the second target value.

### CROSS-REFERENCE TO RELATED APPLICATION

This application is based upon and claims the benefit of priority from Japanese Patent Application No. 2024-158134 filed on Sep. 12, 2024, the content of which is incorporated herein by reference.

### BACKGROUND OF THE INVENTION

### Field of the Invention

The present invention relates to a driving control apparatus for controlling traveling of a vehicle.

### Description of the Related Art

These years, there is a demand for a vehicle control system that leads to improvement of traffic safety and that contributes to development of a sustainable transportation system. As this type of device, a device is conventionally known which selects a single request torque from a plurality of request torques set for each function and executes predetermined engine control based on the selected request torque (for example, see JP 2019-214321 A). In the device described in JP 2019-214321 A, one of a request torque based on an operation amount of an accelerator pedal, a request torque for control of an automatic transmission, or a request torque for vehicle stability control is selected, and an upper limit value for the selected request torque is set.

However, in a configuration in which the upper limit value is set for the request torque selected from the plurality of request torques as in the device described in JP 2019-214321 A, a desired request torque may not be obtained depending on the setting of the request torque and the upper limit value.

### SUMMARY OF THE INVENTION

An aspect of the present invention is a driving control apparatus including a microprocessor configured to perform: outputting a first target value for controlling a predetermined operation of a moving object based on a first operation request for requesting the predetermined operation of the moving object; outputting a second target value for controlling the predetermined operation of the moving object based on a second operation request for requesting the predetermined operation of the moving object; and when the first target value is output and the second target value is output, executing control of the predetermined operation of the moving object based on the first target value and the second target value. The microprocessor is configured to perform: the outputting of the first target value including outputting the first target value such that an upper limit of the first target value is limited to a first upper limit value; the outputting of the second target value including outputting the second target value such that the upper limit of the second target value is not limited or is limited to a second upper limit value greater than the first upper limit value; and the executing including, even when the first target value before being limited to the first upper limit value is greater than the second target value, when the second target value is greater than the first upper limit value, executing the control based on the first target value until a control amount of the predetermined operation reaches the first upper limit value, and executing the control based on the second target value after the control amount of the predetermined operation reaches the first upper limit value.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system of a subject vehicle including a driving control apparatus according to an embodiment of the present invention;

FIG. 2 is a diagram illustrating an example of ASIL set in a driving assistance system;

FIG. 3 is a diagram for explaining braking control according to braking requests from two functions;

FIG. 4 is a block diagram of a configuration of main components of a driving control apparatus according to the present embodiment;

FIG. 5 is a diagram for explaining the braking control by the operation control unit in FIG. 4; and

FIG. 6 is a flowchart illustrating an example of processing to be performed on a CPU of the controller in FIG. 4.

### DETAILED DESCRIPTION

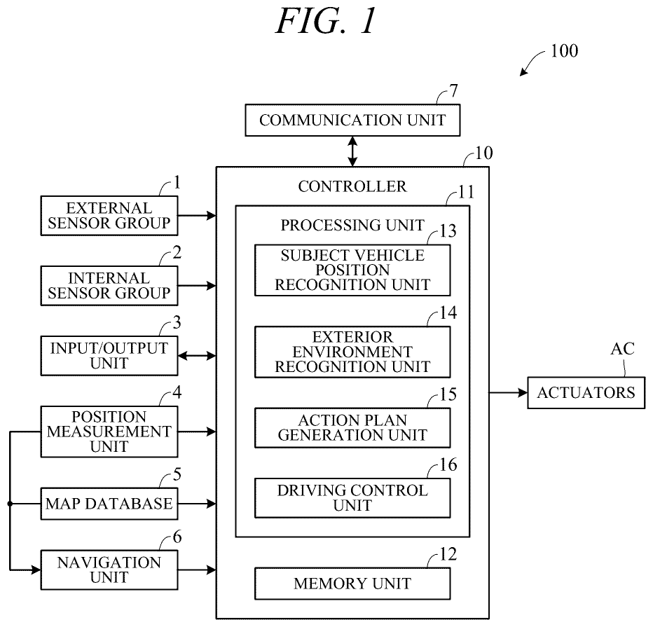

Hereinafter, embodiments of the present invention will be described with reference to FIGS. 1 to 6. A driving control apparatus according to an embodiment of the present invention is applicable to, for example, a vehicle having a self-driving capability, that is, a self-driving vehicle. Note that the driving control apparatus according to an embodiment of the present invention is applicable to both a manual driving vehicle and a self-driving vehicle having a driving assistance capability. However, hereinafter, for convenience of description, a case where the driving control apparatus is applied to the self-driving vehicle will be given as an example. Note that a vehicle to which the driving control apparatus according to this embodiment is applied may be referred to as a subject vehicle in order to be distinguished from other vehicles. The subject vehicle may be any of an engine vehicle having an internal combustion engine (engine) as a driving power source, an electric vehicle having a driving motor as a driving power source, and a hybrid vehicle having an engine and a driving motor as a driving power source. The subject vehicle is capable of driving not only in a self-drive mode that does not require a driver's driving operation but also in a manual drive mode that requires a driver's driving operation.

First, a schematic configuration of the subject vehicle related to self-driving will be described. FIG. 1 is a block diagram schematically illustrating an overall configuration of a vehicle control system 100 of the subject vehicle including a driving control apparatus according to an embodiment of the present invention. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and a traveling actuator AC, each of which is communicably connected with the controller 10.

The “external sensor group 1” is a generic term for a plurality of sensors (external sensors) that detect an external situation that is surrounding information of the subject vehicle. For example, the external sensor group 1 includes a LiDAR that measures scattered light with respect to irradiation light in all directions of the subject vehicle and measures a distance from the subject vehicle to a surrounding obstacle, a radar that detects other vehicles, obstacles, and the like in the surroundings of the subject vehicle by irradiating with electromagnetic waves and detecting reflected waves, and a camera that is mounted on the subject vehicle, that has an imaging element such as a charge coupled device (CCD) or a complementary metal oxide semiconductor (CMOS), and that captures images of the surroundings (forward side, rearward side, and lateral sides) of the subject vehicle.

The “internal sensor group 2” is a generic term for a plurality of sensors (internal sensors) that detect a driving state of the subject vehicle. For example, the internal sensor group 2 includes a vehicle speed sensor that detects a vehicle speed of the subject vehicle, an acceleration sensor that detects acceleration in a front-rear direction of the subject vehicle and acceleration in a left-right direction (lateral acceleration) of the subject vehicle, a rotation sensor that detects the number of rotations of the driving power source, and a yaw rate sensor that detects a rotation angular speed around a vertical axis of the center of gravity of the subject vehicle. The internal sensor group 2 also includes a sensor that detects a driver's driving operation in the manual drive mode, for example, an operation on an accelerator pedal, an operation on a brake pedal, an operation on a steering wheel, and the like.

The input/output device 3 is a generic term for devices into which the driver inputs a command or from which the driver receives a command. For example, the input/output device 3 includes various switches into which the driver inputs various commands by operating an operation member, a microphone into which the driver inputs commands by voice, a display that provides information for the driver via a display image, a speaker that provides information for the driver by sounds, and the like.

The position measurement unit (global navigation satellite system (GNSS) unit) 4 includes a position measurement sensor that receives a positioning signal that has been transmitted from a positioning satellite. The positioning satellite is an artificial satellite such as a global positioning system (GPS) satellite or a quasi-zenith satellite. The position measurement unit 4 uses positioning information that has been received by the position measurement sensor to measure a current position (latitude, longitude, and altitude) of the subject vehicle.

The map database 5 is a device that stores general map information to be used by the navigation unit 6, and includes, for example, a magnetic disk or a semiconductor element. The map information includes position information of roads, information of road shapes (curvatures or the like), and position information of intersections and branch points. Note that the map information stored in the map database 5 is different from highly precise map information stored in a memory unit 12 of the controller 10.

The navigation unit 6 is a device that searches for a target route to a destination on a road that has been input by a driver, and also gives guidance along the target route. The input of the destination and the guidance along the target route are made via the input/output device 3. The target route is calculated, based on a current position of the subject vehicle that has been measured by the position measurement unit 4 and the map information stored in the map database 5. It is possible to measure the current position of the subject vehicle using detection values of the external sensor group 1, and the target route may be calculated, based on the current position and the highly precise map information stored in the memory unit 12.

The communication unit 7 communicates with various servers, not illustrated, via a network including a wireless communication network represented by the Internet network, a mobile telephone network, or the like, and acquires map information, driving history information, traffic information, and the like from the servers regularly or at any timing. Driving history information of the subject vehicle may be transmitted to the server via the communication unit 7 in addition to the acquisition of the driving history information. The network includes not only a public wireless communication network but also a closed communication network provided for every predetermined management area, for example, a wireless LAN, Wi-Fi (registered trademark), Bluetooth (registered trademark), and the like. The map information that has been acquired is output to the map database 5 or the memory unit 12, and the map information is updated.

The actuator AC is a traveling actuator for controlling traveling of the subject vehicle. In a case where the driving power source is an engine, the actuator AC includes a throttle actuator that adjusts an opening (throttle opening) of a throttle valve of the engine. In a case where the driving power source is a traveling motor, the actuator AC includes a traveling motor. The actuator AC also includes a braking actuator that actuates a braking device of the subject vehicle and a rudder actuator that actuates a rudder device.

The controller 10 includes an electronic control unit (ECU). More specifically, the controller 10 includes a computer including a processing unit 11 such as a CPU (microprocessor), the memory unit 12 such as a ROM and a RAM, and other peripheral circuits, not illustrated, such as an I/O interface. Note that a plurality of ECUs having different functions such as an engine control ECU, a driving motor control ECU, and a braking device ECU can be separately provided, but in FIG. 1, the controller 10 is illustrated as an aggregation of these ECUs as a matter of convenience.

The memory unit 12 stores highly precise and detailed road map information for self-driving. The road map information includes road position information, information of a road shape (curvature or the like), information of a road gradient, position information of an intersection or a branch point, information of a type and a position of a division line such as a white line, information of the number of lanes, width of a lane and position information for every lane (information of a center position of a lane or a boundary line of a lane position), position information of a landmark (a traffic light, a sign, a building, or the like) as a mark on a map, and information of a road surface profile such as unevenness of a road surface. The map information stored in the memory unit 12 may include map information that has been acquired from the outside of the subject vehicle via the communication unit 7, or may include map information created by the subject vehicle itself using detection values of the external sensor group 1 or detection values of the external sensor group 1 and the internal sensor group 2. The memory unit 12 also stores information of various control programs and thresholds for use in the programs.

The processing unit 11 includes a subject vehicle position recognition unit 13, an exterior environment recognition unit 14, an action plan generation unit 15, and a driving control unit 16 as functional configurations.

The subject vehicle position recognition unit 13 recognizes a position of the subject vehicle (subject vehicle position) on the map, based on the position information for the subject vehicle that has been obtained by the position measurement unit 4 and the map information in the map database 5. The subject vehicle position may be recognized using the map information stored in the memory unit 12 and surrounding information of the subject vehicle that has been detected by the external sensor group 1, and thus it becomes possible to recognize the subject vehicle position with high accuracy. The movement information (a moving direction and a moving distance) of the subject vehicle may be calculated, based on the detection values of the internal sensor group 2, and thus the subject vehicle position can also be recognized. Note that in a case where the subject vehicle position can be measured by a sensor installed on a road or outside a road side, the subject vehicle position can also be recognized by communicating with the sensor via the communication unit 7.

The exterior environment recognition unit 14 recognizes an external situation in the surroundings of the subject vehicle, based on a signal from the external sensor group 1 such as a LiDAR, a radar, and a camera. For example, a position, a speed, and acceleration of a surrounding vehicle (a forward vehicle or a rearward vehicle) traveling in the surroundings of the subject vehicle, a position of a surrounding vehicle stopped or parked in the surroundings of the subject vehicle, and positions and states of other objects are recognized. The other objects include a sign, a traffic light, a road, a building, a guardrail, a utility pole, a signboard, a pedestrian, a bicycle, and the like. Indications such as division lines (such as white lines) and stop lines on a road surface are also included in the other objects (roads). The states of the other objects include a color (red, green, or yellow) of a traffic light, a moving speed and a direction of a pedestrian or a bicycle, and the like. A part of a stationary object among the other objects constitutes a landmark serving as an index of the position on the map, and the exterior environment recognition unit 14 also recognizes the position and type of the landmark.

The action plan generation unit 15 generates a driving path (target path) of the subject vehicle from a current time to a predetermined time ahead, based on, for example, the target route that has been calculated by the navigation unit 6, the map information stored in the memory unit 12, the subject vehicle position that has been recognized by the subject vehicle position recognition unit 13, and the external situation that has been recognized by the exterior environment recognition unit 14. In a case where there are a plurality of paths that are candidates for the target path on the target route, the action plan generation unit 15 selects, from among the plurality of paths, an optimal path that satisfies criteria such as compliance with laws and regulations and efficient and safe driving, and sets the selected path as the target path. Then, the action plan generation unit 15 generates an action plan corresponding to the target path that has been generated. The action plan generation unit 15 generates various action plans corresponding to driving modes, such as overtaking driving for overtaking a preceding vehicle, lane change driving for changing driving lanes, follow driving for following a preceding vehicle, lane keep driving for keeping the lane not to deviate from the driving lane, deceleration driving, or acceleration driving. In generating the target path, the action plan generation unit 15 first determines a driving mode, and then generates the target path, based on the driving mode.

In the self-drive mode, the driving control unit 16 controls each actuator AC such that the subject vehicle travels along the target path that has been generated by the action plan generation unit 15. More specifically, in consideration of a driving resistance determined by a road gradient or the like in the self-drive mode, the driving control unit 16 calculates a requested driving force for obtaining target acceleration per unit time that has been calculated by the action plan generation unit 15. Then, for example, the actuator AC is feedback-controlled so that actual acceleration that has been detected by the internal sensor group 2 becomes the target acceleration. More specifically, the actuator AC is controlled so that the subject vehicle travels at a target vehicle speed and the target acceleration. Note that in the manual drive mode, the driving control unit 16 controls each of the actuators AC in accordance with a driving command (steering operation or the like) from the driver that has been acquired by the internal sensor group 2.

Incidentally, the self-driving capability includes a plurality of driving assistance systems such as a collision mitigation braking system (CMBS), adaptive cruise control (ACC), a parking assist system (PKS), and an automatic parking system (APS). Hereinafter, the functions implemented in the driving assistance systems may be referred to by the names of the driving assistance systems, such as “CMBS”, “ACC”, “PKS”, and “APS”.

When a subject vehicle is automatically traveling, the controller 10 may simultaneously receive operation requests (braking request, deceleration request, acceleration request, steering request, and the like) from a plurality of functions (driving assistance systems) such as the CMBS, the ACC, the PKS, and the APS. In addition, the same operation request may be simultaneously input from a plurality of functions. For example, when both CMBS and ACC are effective and sudden deceleration (sudden braking) of the forward vehicle is detected, a braking request for avoiding a risk of collision with the forward vehicle may be input from each of the CMBS and the ACC. In such a case, the controller 10 performs adjustment processing (hereinafter, referred to as arbitration) of determining a priority order of each operation request based on a command value (a target value, a control value, or the like) included in each operation request, and selectively executes control according to each operation request.

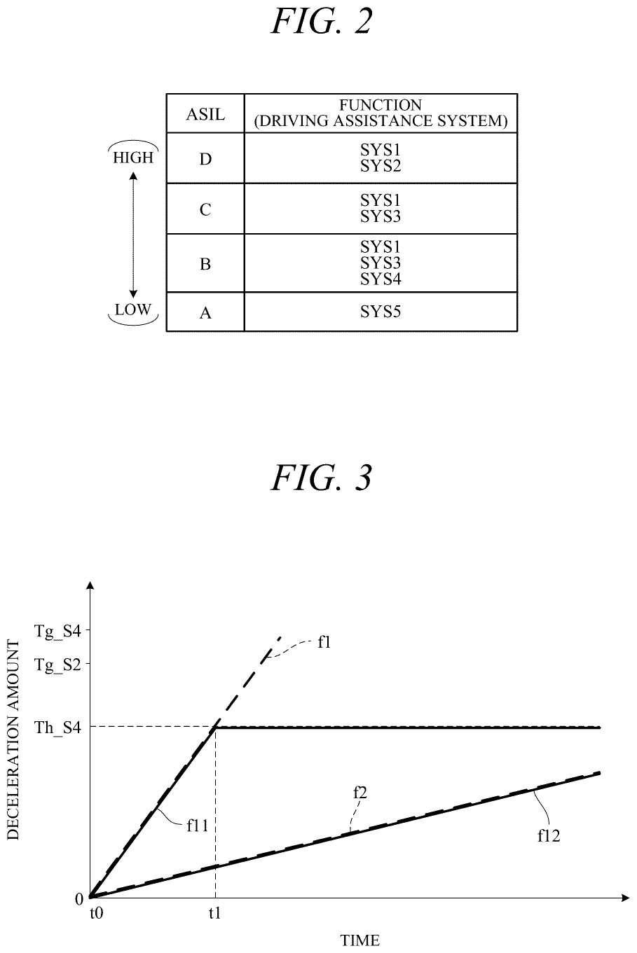

In each driving assistance system, a functional safety level defined by an automotive safety integrity level (ASIL) is set. Therefore, in the arbitration, it is necessary to determine the priority order of each operation request in consideration of the ASIL set in the function (driving assistance system) of the request source of each operation request. FIG. 2 is a diagram illustrating an example of the ASIL set in the driving assistance system. “A”, “B”, “C”, and “D” illustrated in FIG. 2 represent a functional safety level (hereinafter, simply referred to as ASIL) defined by the ASIL, that is, a level of safety required for a function, and “D” is the highest and “A” is the lowest. In the example of FIG. 2, functions SYS1 and SYS2 are classified into ASIL “D”, functions SYS1 and SYS3 are classified into ASIL “C”, functions SYS1, SYS3, and SYS4 are classified into ASIL “B”, and function SYS5 is classified into ASIL “A”. Note that like the functions SYS1 and SYS3, the same function may be classified across a plurality of different levels. For example, a CMBS that can detect a forward vehicle with high accuracy using a plurality of sensors (such as a camera and a radar) in combination is classified into a higher level than a CMBS using a single sensor.

FIG. 3 is a diagram for explaining braking control according to braking requests from two functions. FIG. 3 illustrates a change in a control amount (deceleration amount (=deceleration start traveling speed−current traveling speed)) when braking requests are simultaneously input from two functions SYS2 and SYS4 classified as different ASILs. In FIG. 3, a characteristic f1 indicated by a broken line represents a control value (deceleration) designated by the braking request from the function SYS4, and a characteristic f2 indicated by a broken line represents a control value (deceleration) designated by the braking request from the function SYS2 having an ASIL higher than that of the function SYS4. A characteristic f11 indicated by a solid line represents a change in the control amount when the arbitration is performed based on the target value (target deceleration amount) included in each of the braking requests from two functions. A characteristic f12 indicated by a solid line represents a change in the control amount when the arbitration is performed based on ASILs set in two functions. A target value Tg_S2 represents a target deceleration amount corresponding to the braking request from the function SYS2. A target value Tg_S4 represents a target deceleration amount corresponding to the braking request from the function SYS4. A threshold Th_S4 represents a limit value (upper limit value) set for the target value Tg_S4. This limit value is set based on the ASIL of the function SYS4, that is, ASIL “B”. Note that it is assumed that no limit value is set or a value larger than the limit value Th_S4 is set for the deceleration amount of the function SYS2 classified as ASIL “D”.

As indicated by the characteristic f11 in FIG. 3, when the braking request having a large designated target value (target deceleration amount) is prioritized among the braking requests from two functions, that is, when the braking request from the function SYS4 is prioritized, the deceleration amount remains constant at the limit value Th_S4 (the deceleration is 0) at a time point t1. In this case, the deceleration amount does not reach the target deceleration amount Tg_S2, and as a result, the braking request of the function SYS2 cannot be satisfied. In addition, as indicated by the characteristic f12, when the braking request having a high ASIL of the function of the request source (hereinafter, referred to as a request source function) is prioritized (selected) among the braking requests from the two functions, that is, when the braking request from the function SYS2 is prioritized, the braking control is started at the deceleration indicated by the characteristic f2 from time t0, so that the braking request of the function SYS4 to which a higher deceleration is designated cannot be satisfied. In such a case, it is difficult to satisfactorily avoid a risk of collision with a forward vehicle or the like. To address such problems, this embodiment provides a driving control apparatus having the following configuration.

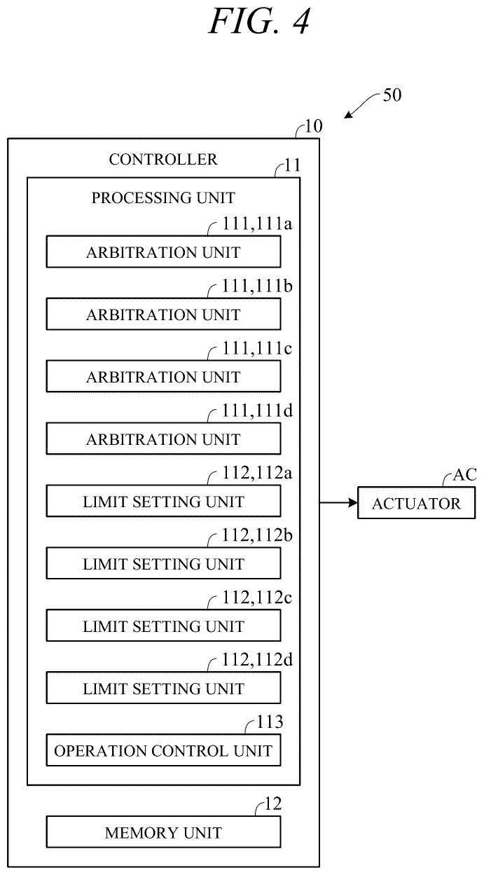

FIG. 4 is a block diagram of a configuration of main components of a driving control apparatus 50 according to the present embodiment. The driving control apparatus 50 constitutes a part of the vehicle control system 100 illustrated in FIG. 1. As illustrated in FIG. 4, the driving control apparatus 50 includes the controller 10 and an actuator AC.

The controller 10 of FIG. 4 includes an arbitration unit 111 (111a, 111b, 111c, 111d), a limit setting unit 112 (112a, 112b, 112c, 112d), and an operation control unit 113 as a functional configuration carried by the processing unit 11 (FIG. 1). In addition, the controller 10 includes the memory unit 12. The arbitration unit 111, the limit setting unit 112, and the operation control unit 113 constitute a part of the driving control unit 16. Note that the arbitration unit 111 and the limit setting unit 112 may be configured as a part of the action plan generation unit 15.

When receiving an operation request from each function (driving assistance system), the arbitration unit 111 sets a command value (a target value, a control value, or the like) for controlling a predetermined operation, based on the operation request. More specifically, the arbitration unit 111 outputs (stores) the command value included in the operation request to the memory unit 12. As illustrated in FIG. 4, the arbitration unit 111 is provided for each ASIL level.

The arbitration unit 111a corresponds to ASIL “A”, and an operation request from a function classified as ASIL “A” is input to the arbitration unit 111a. Similarly, the arbitration unit 111b corresponds to ASIL “B”, the arbitration unit 111c corresponds to ASIL “C”, and the arbitration unit 111d corresponds to ASIL “D”.

Note that when accepting an operation request from each of a plurality of functions classified as a single ASIL, the arbitration unit 111 selects one operation request from among the operation requests according to a predetermined standard. Specifically, the arbitration unit 111 selects the operation request having the largest degree of increase in the control amount indicated by the control value included in each operation request. Then, the arbitration unit 111 stores, in the memory unit 12, the target value included in the selected operation request.

The limit setting unit 112 sets a limit value for the target value included in the operation request, based on the ASIL of the request source function of the operation request input to the arbitration unit 111. More specifically, the limit setting unit 112 sets the limit value for the target value so as to satisfy the functional safety level defined by the ASIL of the request source function. The limit value is stored in the memory unit 12 in association with the target value. As illustrated in FIG. 4, the limit setting unit 112 is provided for each ASIL level.

The limit setting unit 112a corresponds to ASIL “A”, and sets a limit value for a target value included in an operation request from a function classified as ASIL “A”. Similarly, the limit setting unit 112b corresponds to ASIL “B”, the limit setting unit 112c corresponds to ASIL “C”, and the limit setting unit 112d corresponds to ASIL “D”.

The operation control unit 113 executes control of a predetermined operation, based on the target value output from the arbitration unit 111. Here, the operation of the operation control unit 113 will be described using the example of FIG. 3. When braking requests are simultaneously issued from the functions SYS2 and SYS4, the arbitration unit 111 stores each of target values (target deceleration amounts) corresponding to the functions SYS2 and SYS4 in the memory unit 12.

When the values of respective target deceleration amounts are different from each other, the operation control unit 113 selects a target deceleration amount having a large value, reads the selected target deceleration amount from the memory unit 12, and performs the braking control based on the target deceleration amount. In the example of FIG. 3, since the target deceleration amount Tg_S4 corresponding to the function SYS4 is larger than the target deceleration amount Tg_S2 corresponding to the function SYS2, the operation control unit 113 selects the target deceleration amount Tg_S4. However, as in the example of FIG. 3, in a case where the limit value Th_S4 (<target deceleration amount Tg_S2) is set for the target deceleration amount Tg_S4, when the target deceleration amount Tg_S4 is selected, as described above, the deceleration amount does not reach the target deceleration amount Tg_S2, and the braking request of the function SYS2 cannot be satisfied.

In this regard, even in a case where the target deceleration amount Tg_S4 is larger than the target deceleration amount Tg_S2, when the target deceleration amount Tg_S2 is larger than the limit value Th_S4, the operation control unit 113 executes the braking control based on the target deceleration amount Tg_S4 until the time point t1 at which the deceleration amount reaches the limit value Th_S4. When the deceleration amount reaches the limit value Th_S4, the operation control unit 113 executes the braking control based on the target deceleration amount Tg_S2. Note that in the example of FIG. 3, when the control value (deceleration) included in the braking request from the function SYS2 is larger than the control value (deceleration) included in the braking request from the function SYS4, the braking control may be executed from time t0 based on the target deceleration amount Tg_S2.

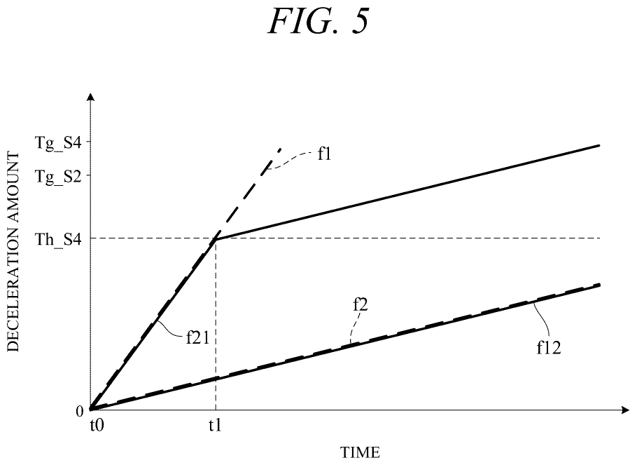

FIG. 5 is a diagram for explaining the braking control by the operation control unit 113. FIG. 5 illustrates an example of the braking control by the operation control unit 113 when two braking requests (the braking requests from two functions SYS2 and SYS4) illustrated in FIG. 3 are input. Since the characteristics f1, f2, and f12 in FIG. 5 are similar to those in the example of FIG. 3, description thereof is omitted. A characteristic f21 indicated by a solid line in FIG. 5 represents a change in the control amount when the braking control by the operation control unit 113 is performed based on the target value (target deceleration amount) and the limit value thereof included in each of the braking requests from the two functions SYS2 and SYS4.

First, based on a target deceleration amount output from the arbitration unit 111 and a limit value set for the target deceleration amount, the operation control unit 113 generates control plan information indicating a timing to switch the target deceleration amount. When the braking request is simultaneously input from the functions SYS2 and SYS4, control plan information as indicated by the characteristic f21 in FIG. 5, that is, control plan information for switching the target deceleration amount at time t1 when the deceleration start time is set to time t0 is generated. The operation control unit 113 performs the braking control according to the generated control plan information. Specifically, the operation control unit 113 performs the braking control based on the target deceleration amount Tg_S4 until the time point t1 at which the deceleration amount reaches the limit value Th_S4, and starts the braking control based on the target deceleration amount Tg_S2 from the time point t1. Accordingly, the deceleration amount increases even after the time t1. As a result, the deceleration amount reaches the target deceleration amount Tg_S2, and the braking request of the function SYS2 can be satisfied.

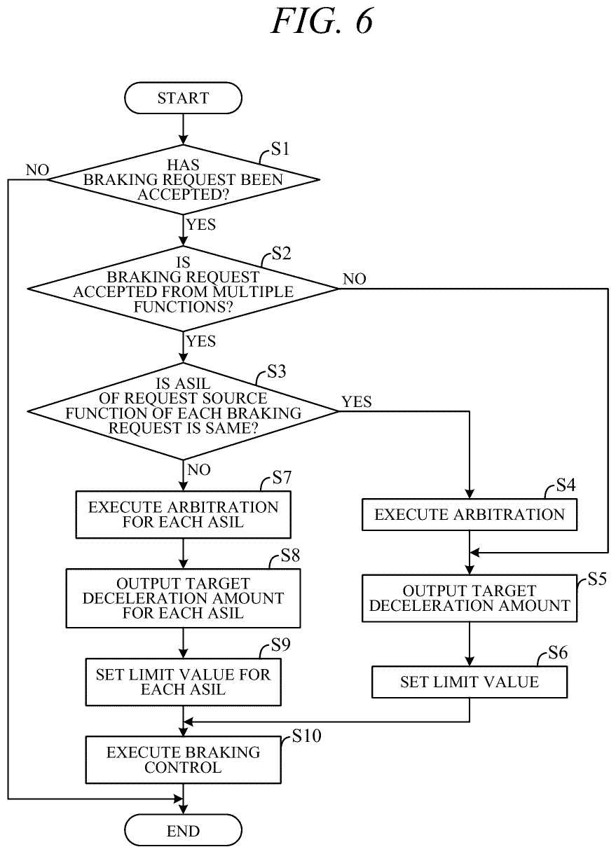

FIG. 6 is a flowchart illustrating an example of processing to be performed on the CPU of the controller 10 in FIG. 4 in accordance with a predetermined program. The processing in this flowchart is, for example, performed at a predetermined cycle while the subject vehicle 101 is traveling in the self-drive mode. Note that although FIG. 6 illustrates an example of the processing when a braking request is input, similar processing is executed in the CPU of the controller 10 even for the operation request other than the braking request.

In step S1, it is determined whether or not a braking request has been accepted. If negative determination is made in step S1, the processing ends. If affirmative determination is made in step S1, it is determined in step S2 whether or not the braking request is accepted from a plurality of functions (driving assistance system). If negative determination is made in step S2, the processing proceeds to step S5. If affirmative determination is made in step S2, it is determined in step S3 whether or not the ASIL of the request source function of each braking request is the same.

If affirmative determination is made in step S3, arbitration for a plurality of braking requests accepted in step S1 is executed in step S4. Specifically, a braking request having the largest degree of increase in the deceleration amount indicated by the control value (deceleration) included in each braking request is selected from the plurality of braking requests. In step S5, the target deceleration amount corresponding to the selected braking request is output (stored) to the memory unit 12. Note that in step S5 executed after the negative determination in step S2, the target deceleration amount included in the braking request accepted in step S1 is stored in the memory unit 12. In step S6, a limit value is set for the target deceleration amount stored in the memory unit 12 in step S5. Specifically, the limit value according to the ASIL of the request source function of the braking request is stored in the memory unit 12 so as to be associated with the target deceleration amount stored in the memory unit 12 in step S5. Note that when the deceleration amount is not limited by the ASIL of the request source function of the braking request, information indicating that there is no limit value is stored in the memory unit 12 in association with the target deceleration amount stored in the memory unit 12 in step S5. The target deceleration amount and the limit value stored in the memory unit 12 in steps S5 and S6 are used for the processing (braking control) of step S10.

If negative determination is made in step S3, in step S7, the plurality of braking requests accepted in step S1 are grouped for each of braking requests having the same ASIL of the request source function, and arbitration similar to step S4 is executed for each group. As a result, for each group, a braking request having the largest degree of increase in the deceleration amount is selected from among one or more braking requests belonging to the group.

In step S8, the target deceleration amount corresponding to each group is output. Specifically, the target deceleration amount included in the braking request selected from each group is stored in the memory unit 12. In step S9, a limit value is set for the target deceleration amount of each group stored in the memory unit 12 in step S8. A method of setting the limit value is similar to that in step S6. The target deceleration amount and the limit value stored in the memory unit 12 in steps S8 and S9 are used for the processing (braking control) of step S10.

In step S10, control plan information is generated based on the target deceleration amount and the limit value stored in the memory unit 12. Then, the braking control is executed according to the control plan information. Specifically, the actuator AC (a brake actuator or the like) is operated according to the control plan information. Note that in step S10 executed after steps S7 to S9, the control plan information is generated based on the target deceleration amount corresponding to each group stored in the memory unit 12 and the limit value corresponding to the ASIL of each group.

In the braking control in step S10 executed after steps S7 to S9, first, the braking control based on the largest target deceleration amount Tg_max among the target deceleration amounts corresponding to respective groups is started according to the control plan information. Specifically, the actuator AC (the brake actuator or the like) is controlled such that the subject vehicle decelerates until the deceleration amount reaches the target deceleration amount Tg_max. Note that when the limit value Th_max is set for the target deceleration amount Tg_max and the limit value Th_max is smaller than the value of the target deceleration amount Tg_max, the braking control based on the target deceleration amount Tg_max ends at a time point when the deceleration amount reaches the limit value Th_max. Note that when one or more target deceleration amounts having values larger than the limit value Th_max are present in the target deceleration amounts corresponding to respective groups, the braking control based on a target deceleration amount Tg_2nd, which is next largest after the target deceleration amount Tg_max, is started after the deceleration amount reaches the limit value Th_max.

Note that when a limit value Th_2nd is set for the target deceleration amount Tg_2nd and the limit value Th_2nd is smaller than the limit value Th_max, the braking control based on a target deceleration amount Tg_3rd, which is the next largest after the target deceleration amount Tg_2nd, is started. In this manner, the braking control is executed according to the control plan information such that the deceleration amount becomes the final target deceleration amount.

According to the embodiment of the present invention, the following operation and effect are achievable.

(1) The driving control apparatus 50 includes the arbitration unit 111 which outputs a first target value for controlling a predetermined operation based on a first operation request for requesting a predetermined operation (for example, braking) of a subject vehicle and outputs a second target value for controlling the predetermined operation based on a second operation request for requesting a predetermined operation of the subject vehicle, and an operation control unit 113 which controls the predetermined operation of the subject vehicle based on the first target value and the second target value when the first target value is output from the arbitration unit 111 and the second target value is output from the arbitration unit 111. The arbitration unit 111 outputs the first target value so as to limit an upper limit of the first target value to a first upper limit value, and outputs the second target value so as not to limit an upper limit of the second target value or to limit the upper limit of the second target value to a second upper limit value larger than the first upper limit value. Even in a case where the first target value (the target value Tg_S4 in the example of FIG. 3) is larger than the second target value (the target value Tg_S2 in the example of FIG. 3), when the second target value is larger than the first upper limit value (the threshold Th_S4 in the example of FIG. 3), the operation control unit 113 controls the predetermined operation based on the first target value until a control amount of the predetermined operation reaches the first upper limit value, and controls the predetermined operation based on the second target value after the control amount of the predetermined operation reaches the first upper limit value.

As described above, operation control is first performed based on the first target value larger than the second target value, and the operation control based on the second target value is started after the first upper limit value smaller than the second target value is reached, so that the operation control exceeding the first upper limit value can be performed as compared with a case of simply selecting a largest first target value. In addition, by performing the operation control based on a larger target value (first target value) at an initial stage of the operation control, the operation control can be appropriately executed according to a situation. Accordingly, driving control of a vehicle equipped with a plurality of driving assistance systems can be executed satisfactorily.

Further, based on the target values (the first target value and the second target value) and the limit values (the first upper limit value and the second upper limit value) for controlling the predetermined operation, the operation based on the first target value is switched to the operation based on the second target value, so that occurrence of a time lag at a time of operation switching can be suppressed. As a result, even when a plurality of operation requests including different target values are accepted, the control amount can be caused to seamlessly reach a final target value. As a result, the driving control of the vehicle equipped with the plurality of driving assistance systems can be executed smoothly.

(2) The operation control unit 113 generates control plan information based on the first target value and the second target value, and controls a predetermined operation based on the control plan information. Furthermore, even in a case where the first target value is larger than the second target value, when the second target value is larger than the first upper limit value, the operation control unit 113 generates the control plan information such that control of the predetermined operation based on the first target value is performed until the control amount of the predetermined operation reaches the first upper limit value, and when the control amount reaches the first upper limit value, control of the predetermined operation based on the first target value is ended and control of the predetermined operation based on the second target value is started. As described above, by generating the control plan information before starting the control of the predetermined operation, processing for determining an operation switching timing while feeding back the control amount becomes unnecessary. Accordingly, switching from the operation based on the first target value to the operation based on the second target value can be seamlessly executed without causing a time lag.

(3) A degree of increase in the control amount when the operation control unit 113 controls the predetermined operation based on the first target value is larger than a degree of increase in the control amount when the operation control unit 113 controls the predetermined operation based on the second target value. Accordingly, the control amount increases with a steep slope based on the first target value until the first upper limit value is reached, and the control amount increases with a gentle slope toward the second target value smaller than the first target value after the first upper limit value is reached. As a result, the degree of increase in the control amount can be appropriately controlled in accordance with the target value and the upper limit value.

(4) When accepting a plurality of first operation requests, the arbitration unit 111 selects the first operation request, which has a largest degree of increase in the control amount of the predetermined operation, among the plurality of first operation requests, and then outputs the first target value such that its upper limit is limited to the first upper limit value. When accepting a plurality of second operation requests in which the second target value is not limited by the upper limit value, the arbitration unit 111 selects the second operation request, which has a largest degree of increase in the control amount of the predetermined operation, among the plurality of second operation requests, and then outputs the second target value. When accepting a plurality of second operation requests in which the second target value is limited by the second upper limit value, the arbitration unit 111 selects the second operation request, which has a largest degree of increase in the control amount of the predetermined operation, among the plurality of second operation requests, and then outputs the second target value such that an upper limit of the second target value is limited to the second upper limit value. As described above, by determining how to control the operation at an arbitration stage, specifically, by determining a target value used for control of an operation, switching from the operation based on the first target value to the operation based on the second target value can be smoothly executed.

The above embodiment can be modified in various manners. Hereinafter, modifications will be described. In the above embodiment, the driving control apparatus 50 is applied to a self-driving vehicle; however, the driving control apparatus 50 is also applicable to other types of vehicles. For example, the driving control apparatus 50 is also applicable to manual driving vehicles equipped with advanced driver-assistance systems (ADAS).

In addition, in the above embodiment, the arbitration unit 111 and the limit setting unit 112 as a first target output unit output the first target value based on the first operation request for requesting the predetermined operation of the subject vehicle, such that the upper limit of the first target value for controlling the predetermined operation is limited to the first upper limit value. The arbitration unit 111 and the limit setting unit 112 as a second target output unit output the second target value based on the second operation request for requesting the predetermined operation of the subject vehicle, such that the upper limit of the second target value for controlling the predetermined operation is not limited or the upper limit of the second target value is limited to the second upper limit value larger than the first upper limit value. However, an operation request for requesting a predetermined operation (braking, deceleration, or the like) may be input to the first target output unit and the second target output unit from a driving assistance system included in a moving object, such as a self-propelled robot, other than a vehicle. That is, the moving object to which the driving control apparatus 50 is applied may be a moving object other than the vehicle.

Furthermore, in the above embodiment, the arbitration unit 111 arbitrates an operation request based on four-stage functional safety levels defined by the ASIL. Then, the limit setting unit 112 sets a limit value for the target value included in the operation request, based on the ASIL of the request source function of the operation request input to the arbitration unit 111. However, the arbitration of the operation request may be performed based on five-stage levels obtained by adding, to the four-stage levels “D”, “C”, “B”, and “A” defined by the ASIL, “QM” indicating that the functional safety level defined by the ASIL is not set. In this case, each of the arbitration unit 111 and the limit setting unit 112 corresponding to the level “QM” is provided in the driving control apparatus 50. In addition, arbitration of the operation request may be performed based on a functional safety level defined by a standard other than the ASIL. In addition, the limit value for the target value included in the operation request may be set so as to satisfy the functional safety level defined by the standard other than the ASIL.

The above embodiment can be combined as desired with one or more of the above modifications. The modifications can also be combined with one another.

According to the present invention, the driving control of the vehicle can be performed satisfactorily and smoothly.

Above, while the present invention has been described with reference to the preferred embodiments thereof, it will be understood, by those skilled in the art, that various changes and modifications may be made thereto without departing from the scope of the appended claims.

What is claimed is:

1. A driving control apparatus comprising
a microprocessor configured to perform:
outputting a first target value for controlling a predetermined operation of a moving object based on a first operation request for requesting the predetermined operation of the moving object;
outputting a second target value for controlling the predetermined operation of the moving object based on a second operation request for requesting the predetermined operation of the moving object; and
when the first target value is output and the second target value is output, executing control of the predetermined operation of the moving object based on the first target value and the second target value; wherein
the microprocessor is configured to perform:
the outputting of the first target value including outputting the first target value such that an upper limit of the first target value is limited to a first upper limit value;
the outputting of the second target value including outputting the second target value such that the upper limit of the second target value is not limited or is limited to a second upper limit value greater than the first upper limit value; and
the executing including, even when the first target value before being limited to the first upper limit value is greater than the second target value, when the second target value is greater than the first upper limit value, executing the control based on the first target value until a control amount of the predetermined operation reaches the first upper limit value, and executing the control based on the second target value after the control amount of the predetermined operation reaches the first upper limit value.

2. The driving control apparatus according to claim 1, wherein
a degree of increase in the control amount when the predetermined operation is controlled based on the first target value is greater than a degree of increase in the control amount when the predetermined operation is controlled based on the second target value.

3. The driving control apparatus according to claim 1, wherein
the microprocessor is configured to perform:
the outputting of the first target value including, when a plurality of the first operation requests are accepted, selecting, from among the plurality of first operation requests, the first operation request having the largest degree of increase in the control amount of the predetermined operation, and outputting the first target value such that the upper limit thereof is limited to the first upper limit value; and
the outputting of the second target value including, when a plurality of the second operation requests in which the second target value is not limited by an upper limit value are accepted, selecting, from among the plurality of second operation requests, the second operation request having the largest degree of increase in the control amount of the predetermined operation, and outputting the second target value, whereas when a plurality of the second operation requests in which the second target value is limited by the second upper limit value are accepted, selecting, from among the plurality of second operation requests, the second operation request having the largest degree of increase in the control amount of the predetermined operation, and outputting the second target value such that the upper limit thereof is limited to the second upper limit value.

4. The driving control apparatus according to claim 1, wherein
the microprocessor is configured to perform:
the executing including generating control plan information based on the first target value and the second target value, and executing the control based on the control plan information; and
the generating including, when the first target value before being limited to the first upper limit value is greater than the second target value, and when the second target value is greater than the first upper limit value, generating the control plan information such that control of the predetermined operation based on the first target value is performed until the control amount of the predetermined operation reaches the first upper limit value, and when the control amount reaches the first upper limit value, control of the predetermined operation based on the first target value is ended and control of the predetermined operation based on the second target value is started.

5. The driving control apparatus according to claim 4, wherein
the moving object is a vehicle;
the vehicle further comprises an actuator for traveling of the vehicle; and
the microprocessor is configured to perform the executing including controlling the actuator in accordance with the control plan information.
